(19) United States
(12) Patent Application Publication
(10) Pub. No.: US 2002/0117897 A1
(43) Pub. Date: Aug. 29, 2002

(54) Feeder system

(75) Inventor: Hideo Takahashi, Susono-shi (JP)

Correspondence Address: SUGHRUE MION, PLLC, 2100 PENNSYLVANIA AVENUE, N.W., WASHINGTON, DC, 20037, US

(73) Assignee: YAZAKI CORPORATION

(21) Appl. No.: 10/081,193

(22) Filed: Feb. 25, 2002

(30) Foreign Application Priority Data
Feb. 27, 2001 (JP) P2001-052980

(51) Int. Cl. B60L 1/00

(52) U.S. Cl. 307/10.1

(57) ABSTRACT

A first feeder unit includes a first feeding portion having a primary coil, a first communication portion for transmitting a control signal, and a first external connecting portion, these component members being grouped together as a set and arranged in a unit. A second feeder unit is provided which includes at least a second feeding portion having a secondary coil, a second communication portion for receiving the control signal, a second external connecting portion, and a load controlling portion to which the second communication portion for controlling the load, these component members being grouped together as a set and arranged in a unit. The first feeder unit and the second feeder unit are respectively arranged to be detachable from a vehicle body and a sliding door serving as the two members.

### BACKGROUND OF THE INVENTION

The present invention relates to a feeder system for supplying electric power from one of two members located in proximity to each other to the other member through the action of mutual induction.

As a feeder system of this type, a feeder system for supplying electric power from a vehicle body of an automobile to a door unit or from the vehicle body to a sliding door is known.

FIG. 7 is a schematic diagram illustrating a state in which related feeder systems are respectively installed in four door units, and FIG. 8 is an enlarged diagram of an essential portion shown in FIG. 7.

In FIGS. 7 and 8, four door units 102 are openably provided in a vehicle body 101 of an automobile, and are arranged such that electric power is supplied to the respective door units 102 from the vehicle body 101. Namely, the vehicle body 101 is provided with a first communication device 103 and four primary-side electromagnetic couplers 104 disposed at opening/closing portions of the respective door units 102. The four primary-side electromagnetic couplers 104 are connected to the first communication device 103 through a wire harness 105.

Each door unit 102 is provided with a secondary-side electromagnetic coupler 106 opposing the primary-side electromagnetic coupler 104. Each door unit 102 is provided with a second communication device 108 which is connected to the secondary-side electromagnetic coupler 106 through a wire harness 107, a charger 110 having a diode bridge 109, and a door-side battery 111.

It should be noted that reference numeral 112 denotes electrical equipment provided in the door unit 102; 113, a switch for the electrical equipment; and 114, an automatic gain control incorporated in the second communication device 108.

With the above-described related art, since the aforementioned component members must be fixed one by one to the vehicle body 101 or the door unit 102, the assembly has been complicated, and has affected the operating efficiency. Since it is necessary to proceed with the operation while securing a space when the aforementioned component members are fixed, it has been difficult to make the feeder apparatus compact. Since each of the component members is fixed, the removal is very troublesome, which has affected the maintainability.

### SUMMARY OF THE INVENTION

The invention has been devised in view of the above-described circumstances, and its object is to provide a feeder system which facilitates assembly and maintenance and is compact.

In order to solve the aforesaid object, the invention is characterized by having the following arrangement.

(1) A feeder system comprising:

a first feeder unit which is detachably provided to a first member, and includes, as an integrated unit, a first feeding portion having a primary coil, a first communication portion for transmitting a control signal for a load to be driven, and a first external connecting portion for connecting the first feeding portion and the first communication portion, to an external circuit; and

a second feeder unit which is detachably provided to a second member adapted to be brought in to close proximity to the first member, and includes, as a integrated unit, a second feeding portion having a secondary coil which generates an induced electromotive force as the primary coil is brought into close proximity thereto, a second communication portion for receiving the control signal transmitted from the first communication portion, a second external connecting portion to which the load is connected, and a load controlling portion to which the second feeding portion, the second communication portion, and the second external connecting portion are connected and which controls the driving of the load.

(2) The feeder system according to (1), wherein the second feeder unit includes a charging portion having a storage member capable of being charged with electric power supplied from the second feeding portion.

(3) The feeder system according to (2), wherein the storage member is detachable from the second feeder unit.

(4) The feeder system according to claim (1), wherein the load controlling portion is directly or indirectly connected to the second feeding portion, the second communication portion, and the second external connecting portion.

(5) The feeder system according to (1), wherein the first member is a vehicle body, and the second member is a slide door mounted on the vehicle body.

### BRIEF DESCRIPTION OF THE DRAWINGS

FIG. 1 is a block diagram illustrating a basic configuration of an embodiment in which the feeder system in accordance with the invention is applied to a sliding door for an automobile;

FIG. 2 is a block diagram illustrating a specific example of the configuration shown in FIG. 1;

FIG. 3 is a block diagram illustrating another example of a second feeder unit shown in FIG. 1;

FIG. 4 is a block diagram illustrating a specific example of the configuration shown in FIG. 3;

FIG. 5 is a block diagram illustrating still another example of the second feeder unit shown in FIG. 1;

FIG. 6 is a block diagram illustrating a specific example of the configuration shown in FIG. 5;

FIG. 7 is a schematic diagram illustrating a state in which related feeder systems are respectively installed in four door units; and

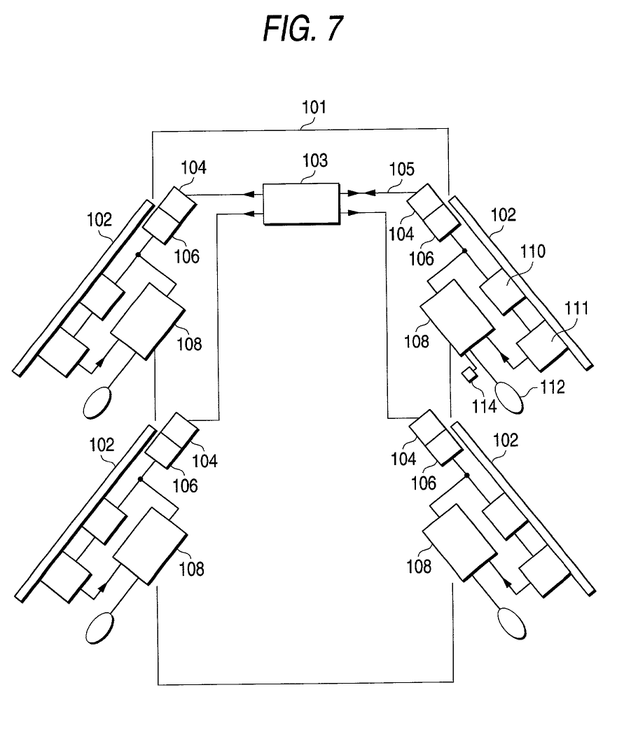

FIG. 8 is an enlarged diagram of an essential portion shown in FIG. 7.

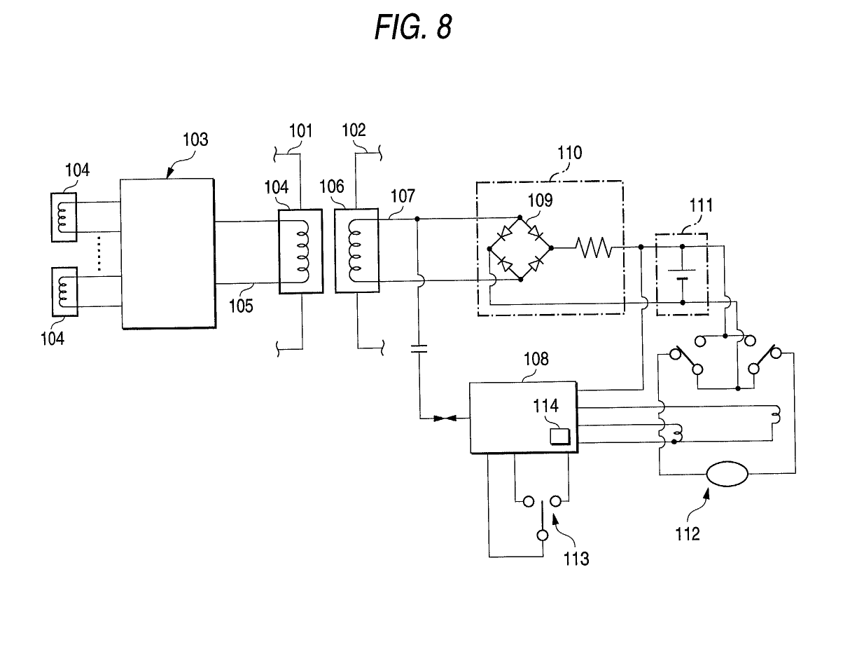

### DETAILED DESCRIPTION OF PREFERRED EMBODIMENTS

Referring now to the drawings, a description will be given of an embodiment of the invention.

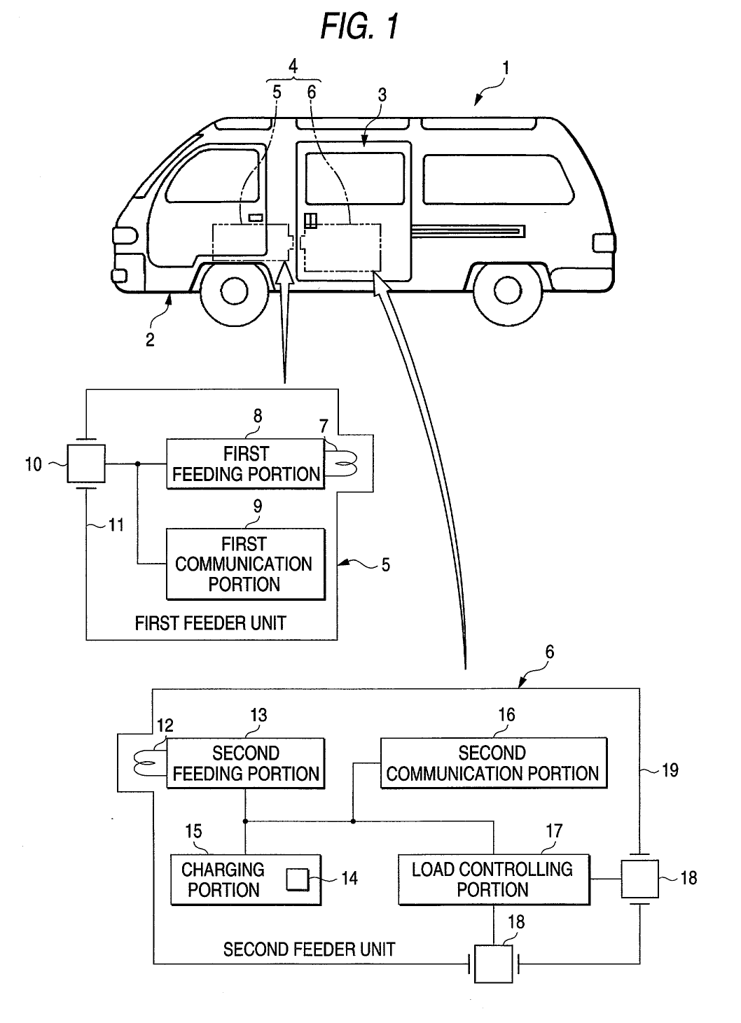

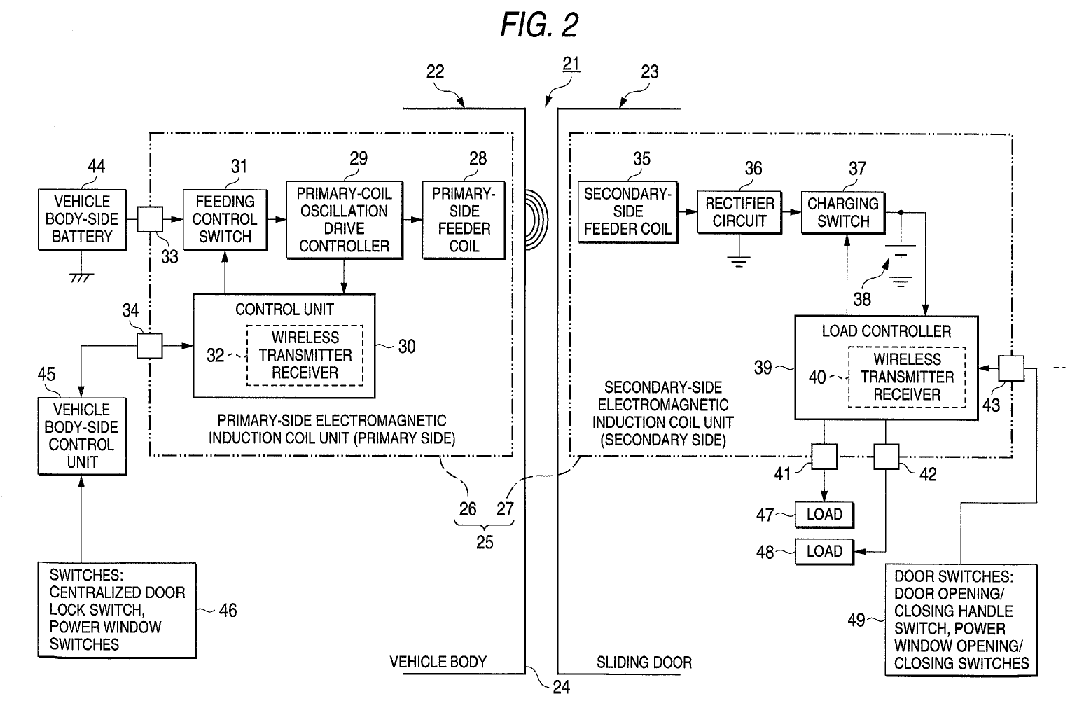

FIG. 1 is a block diagram illustrating a basic configuration of an embodiment in which the feeder system according to the invention is applied to a sliding door for an automobile. FIG. 2 is a block diagram illustrating a specific example of the configuration shown in FIG.

In FIG. 1, at a door joining portion for joining, on the one hand, a vehicle body 2 of an automobile 1 corresponding to one of two members and, on the other hand, a sliding door 3 provided slidably to the vehicle body 2 and corresponding to the other one of the two members, a feeder system 4 is provided for supplying electric power from the vehicle body 2 to the sliding door 3 through the action of mutual induction. The feeder system 4 is comprised of a first feeder unit 5 detachably provided to the vehicle body 2 and a second feeder unit 6 detachably provided to the sliding door 3.

The first feeder unit 5 includes at least a first feeding portion 8 having a primary coil 7, a first communication portion 9, and a first external connecting portion 10, these members being accommodated in a casing 11 and being grouped together as a set. The second feeder unit 6 includes at least a second feeding portion 13 having a secondary coil 12, a charging portion 15 having a storage member 14, a second communication portion 16, a load controlling portion 17, and a second external connecting portion 18, these members being accommodated in a casing 19 and being grouped together as a set.

It should be noted that the casing 11 and the casing 19 may be formed in such a manner that they can be respectively fixed easily to the vehicle body 2 and the sliding door 3 by an appropriate fixing portion such as screw cramps, which are not particularly shown (in the case of the screw cramps, the removal is facilitated). The first external connecting portion 10 and the second external connecting portion 18 may be either singular or plural. The first external connecting portion 10 and the second external connecting portion 18 is preferably disposed so as to assume an optimum positional relationship with a mating member of connection such as a load.

The first feeding portion 8 is arranged to receive the supply of electric power from a vehicle body-side battery through the first external connecting portion 10 and to supply an AC electromotive force to the primary coil 7. The first external connecting portion 10 is formed as a connector, for example.

The first communication portion 9 is arranged to be able to transmit a control signal to a load to be driven such as a power window of the sliding door 3. Incidentally, the transmission (communication) is effected by wireless, but the transmitting portion may utilize optical communication or infrared rays. It is assumed that, in this embodiment, the first communication portion 9 has a function concerning the reception.

The second feeding portion 13 is so arranged that the secondary coil 12 thereof is brought into close proximity to the primary coil 7 when the sliding door 3 is closed. The second feeding portion 13 is so configured as to have the function of effecting the AC-DC conversion of the induced electromotive force occurring in the secondary coil 12 by utilizing the action of mutual induction with respect to the primary coil 7 and the function of rectifying the DC current.

The charging portion 15 is so configured as to have the function of charging the storage member 14 with the electric power supplied from the second feeding portion 13. Incidentally, the storage member 14 includes a capacitor or a secondary battery, or a plurality of such members connected in parallel. As the storage member 14, one which satisfies characteristic requirements of the load may be selected appropriately.

The second communication portion 16 is arranged to be able to receive the control signal transmitted from the first communication portion 9. Further, the second communication portion 16 in this embodiment is provided with the function concerning the transmission (similar to the one described above).

The storage member 14, the second communication portion 16, and the second external connecting portion 18 are connected to the load controlling portion 17. The load controlling portion 17 is arranged to be able to control the driving of the load such as a power window on the basis the control signal received by the second communication portion 16 or the operation signal of the switch provided on the sliding door 3.

The second external connection portion 18 is a portion to which the load is connected, and is formed as a connector, for example.

As described above, the feeder system 4 has the first feeder unit 5 and the second feeder unit 6 which are arranged in units in each of which the respective components are grouped together as a set. In addition, the first feeder unit 5 and the second feeder unit 6 are respectively constructed so as to be detachable with respect to the vehicle body 2 and the sliding door 3.

Accordingly, the feeder system 4 can be installed in units on the vehicle body 2 and the sliding door 3, respectively. Consequently, the operating efficiency concerning the assembly can be improved remarkably over the related feeder system. In addition, by improving the operating efficiency, it is possible to attain a reduction in cost.

The feeder system 4 can be removed from the vehicle body 2 and the sliding door 3 in units of the first feeder unit 5 and the second feeder unit 6. Consequently, the maintenance can be made easier than in the conventional case. In addition, by facilitating the maintenance, it is possible to attain a reduction in the cost concerning the maintenance.

Since the component parts are arranged in sets, the feeder system 4 can be made compact in size. In consequence, not only can the operating efficiency improve, but also a reduction of the wire harness can be attained. In addition, by reducing the wire harness, the weight of the vehicle 1 becomes lightweight, thereby contributing to the improvement of fuel consumption.

In accordance with the invention, it is possible to provide the feeder system 4 for an automobile-use sliding door which facilitates assembly and maintenance and is compact.

Next, the configuration of the feeder system will be described more specifically with reference to FIG. 2.

In FIG. 2, it is assumed that a sliding door 23 is installed in a vehicle body 22 of an automobile 21 in such a manner as to be slidable in the longitudinal direction of the vehicle body 22. Reference numeral 24 denotes an open frame portion for the sliding door 23, which is provided in the vehicle body 22. A feeder system 25 for supplying electric power through the action of mutual induction is provided at a door joining portion of the open frame portion 24. The feeder system 25 is provided in such a manner as to straddle the vehicle body 22 and the sliding door 23, and has a primary-side electromagnetic induction coil unit 26 and a secondary-side electromagnetic induction coil unit 27 which are capable of supplying electric power with the sliding door 23 closed.

The primary-side electromagnetic induction coil unit 26 is detachably provided in the open frame portion 24 on the vehicle body 22 side, and is comprised of a primary-side feeder coil 28, a primary-coil oscillation drive controller 29, a control unit 30, a feeding control switch (feeding control SW) 31, a wireless transmitter receiver 32, and connectors 33 and 34 serving as the first external connecting portions, all of these component parts being accommodated in an unillustrated casing. The primary-side feeder coil 28 is connected to the primary-coil oscillation drive controller 29 which is connected to the control unit 30 and the feeding control switch 31. The feeding control switch 31, which is connected to the connector 33, and the connector 34 are connected to the control unit 30.

The secondary-side electromagnetic induction coil unit 27 is detachably provided on the sliding door 23 in such a manner as to oppose the primary-side electromagnetic induction coil unit 26, and is comprised of a secondary-side feeder coil 35 for power supply which is brought into close proximity to the aforementioned primary-side feeder coil 28, a rectifier circuit 36, a charging switch (charging SW) 37 and a storage member 38 both serving as the charging portion, a load controller 39 serving as the load controlling portion, a wireless transmitter receiver 40 serving as the second communication portion, and connectors 41 to 43 serving as the second external connection portions. These component parts are accommodated in an unillustrated casing. In addition, the secondary-side feeder coil 35 is connected to the rectifier circuit 36. The rectifier circuit 36 is connected to the charging switch 37. The storage member 38 is connected to the charging switch 37. The charging switch 37, the storage member 38, and the connectors 41 to 43 are connected to the load controller 39.

It should be noted that, in this example, the vehicle body 22 corresponds to one of the two members recited in the claims, and the sliding door 23 corresponds to the other one of the two members recited in the claims. The primary-side electromagnetic induction coil unit 26 corresponds to the first feeder unit recited in the claims, and the secondary-side electromagnetic induction coil unit 27 corresponds to the second feeder unit recited in the claims. The primary-side feeder coil 28 corresponds to the primary coil recited in the claims, while the secondary-side feeder coil 35 corresponds to the secondary coil recited in the claims. The primary-side feeder coil 28, the primary-coil oscillation drive controller 29, the control unit 30, and the feeding control switch 31 correspond to the first feeding portion recited in the claims, and the secondary-side feeder coil 35 and the rectifier circuit 36 correspond to the second feeding portion recited in the claims.

The vehicle body 22 is provided with a vehicle-side battery 44 and a vehicle-side control unit 45 in addition to the above-described primary-side electromagnetic induction coil unit 26. The vehicle-side control unit 45 is adapted to be connected to the control unit 30 through the connector 34 when the primary-side electromagnetic induction coil unit 26 is installed ion the vehicle body 22. Switches 46 and an unillustrated sliding-door open/closed-state confirming unit (e.g., a known curtsey switch) are connected to the vehicle-side control unit 45. An unillustrated ignition switch is provided on a power line of the vehicle-side battery 44.

The sliding door 23 is provided with loads 47 and 48 respectively connected to the connectors 41 and 42 as well as door switches 49 connected to the connector 43, in addition to the aforementioned secondary-side electromagnetic induction coil unit 27.

The primary-side feeder coil 28 is one having a known configuration, and a covering made of a synthetic resin is provided on its surface so as to have an effect against splashing with water (such as splashing with drops of water from the outside). A portion of the primary-side feeder coil 28 is adapted to be exposed from the open frame portion 24, and is formed such that the secondary-side feeder coil 35 is capable of opposing and approaching the same.

The primary-coil oscillation drive controller 29 is arranged to control the oscillation and driving of the primary-side feeder coil 28. In other words, the primary-coil oscillation drive controller 9 has the function of an inverter and the function of switching it, and is arranged to be able to control the excitation of the primary-side feeder coil 28. The primary-coil oscillation drive controller 29 is configured by including an unillustrated microprocessor.

The control unit 30 is arranged to monitor the operating state of the primary-coil oscillation drive controller 29 and to control the turning on and off of the feeding control switch 31. The control unit 30 includes an unillustrated microprocessor and the like.

The feeding control switch 31 is, for instance, a relay having a known configuration, and its on/off state is controlled by the control unit 30. The supply of electric power to the primary-side electromagnetic induction coil unit 26 can be controlled by turning on and off the feeding control switch 31.

The wireless transmitter receiver 32 is incorporated in the control unit 30 (or may be a separate member). The wireless transmitter receiver 32 is configured as a device for transmitting and receiving a control signal to and from the wireless transmitter receiver 40 of the sliding door 23, which will be described later, by wireless. For instance, if the driver operates a power window switch for a power window of the sliding door 23, the wireless transmitter receiver 32 transmits to the wireless transmitter receiver 40 a control signal for opening or closing the window of the sliding door 23. It should be noted that although in this embodiment the wireless transmitter receiver 32 is arranged to transmit and receive various control signals by wireless, the wireless transmitter receiver 32 may be alternatively arranged to transmit and receive them by electromagnetic induction (the action of mutual induction) (the configuration of the first feeding portion may be applied). Still further, the wireless transmitter receiver 32 may transmit and receive the control signals by communication using light, infrared rays, or the like.

The vehicle body-side control unit 45 controls various equipment provided in the vehicle body 22, for instance, and is configured by an unillustrated microprocessor and its peripheral circuits.

The aforementioned microprocessor is configured by including a ROM, a CPU, an EEPROM, a RAM, input/output ports, and the like which are not shown. The ROM is a read-only memory, and a program and fixed data are stored therein. In addition, the CPU is a central processor unit, and is operated in accordance with a control program stored in advance in the ROM. The EEPROM is a read-only memory which is electrically erasable and rewritable, and various set value information and the like are stored therein. The RAM is a random access memory, and has a data area for storing various data used in the process of processing by the CPU as well as a work area which is used at the time of processing.

As the aforementioned switches 46, it is possible to cite various switches including a centralized door lock switch and power window switches.

Incidentally, a brief description will be given here of the sliding mechanism of the sliding door 23. The sliding door 23 is provided with an arm-like door stay located in its lower portion. The door stay is arranged to be guided by a rail portion provided in the lower portion of the open frame portion 24 of the vehicle body 22. Namely, an unillustrated roller is provided at a tip of the door stay, and the roller is adapted to slide on the rail portion. The door stay is adapted to move in the longitudinal direction of the vehicle body 22 together with the door stay.

The secondary-side feeder coil 35 is one having a known configuration, and a covering made of a synthetic resin is provided on its surface so as to demonstrate an effect with respect to splashing with water (such as splashing with drops of water from the outside). A portion of the secondary-side feeder coil 35 is disposed and formed such that the secondary-side feeder coil 35 is capable of opposing and approaching the aforementioned portion of the primary-side feeder coil 28.

The rectifier circuit 36 is a circuit for rectifying the induced electromotive force occurring in the secondary-side feeder coil 35, and is configured by a diode and a capacitor which are not shown. Incidentally, the rectifier circuit 36 may be integrally provided with a charging circuit capable of charging the storage member 38 with the induced electromotive force occurring in the secondary-side feeder coil 35.

The charging switch 37 is, for instance, a relay having a known configuration, and is capable of controlling the charging of the storage member 38 as the charging switch 37 is turned on and off by being controlled by the load controller 39.

A device including a capacitor or a secondary battery, or a plurality of such members connected in parallel, are used as the storage member 38, (as the storage member 38, one which satisfies the characteristic requirements of the load may be selected appropriately) The charging of the storage member 38 is controlled by being turned on or off by the charging switch 37. In addition, the storage member 38 is adapted to be able to supply electric power to the load controller 39.

A large-capacity storage member such as the vehicle body-side battery 44 is not required for the storage member 38. A compact one having a capacity sufficient to drive the control circuits of the loads 47 and 48 and the load controller 39 is used. In addition, the storage member 38 is installed replaceably in the sliding door 23.

It should be noted that as the capacitor, a large-capacity type device such as an electric double layer capacitor or a polyacen capacitor is preferable. As the capacity, 20 to 500 F is desirable. It suffices to select one having an appropriate capacity within the range which makes it possible to drive the loads 47 and 48, for example. It goes without saying that if a capacitor having a necessary and minimum capacity is selected, it is possible to reduce the weight, shorten the charging time, make the space compact, lower the cost, and reduce the amount of electric power generated by the vehicle body-side battery 44. The secondary battery may be appropriately selected from among a lead-acid accumulator, a nickel-cadmium battery, a nickel-hydrogen battery, a lithium-ion battery, and the like. The battery having an appropriate capacity (or a necessary and minimum capacity) and a compact size suffices the second battery.

The load controller 39 is for controlling the driving of the various loads 47 and 48 provided in the sliding door 23, and is configured by having the unillustrated microprocessor, its peripheral circuits, and the like, as described above. The load controller 39 is arranged to monitor the state of charging (charging rate) of the storage member 38. The load controller 39 is arranged to control the on/off state of the charging switch 37.

The wireless transmitter receiver 40 is incorporated in the load controller 39 (or may be a separate member). The wireless transmitter receiver 40 is configured as a device for transmitting and receiving the control signal with respect to the loads 47 and 48 to and from the wireless transmitter receiver 32 on the vehicle body 22 side.

As the door switches 49, it is possible to cite various switches including door opening/closing handle switches and power window opening/closing switches. As the loads 47 and 48, it is possible to cite various intermittent loads including power windows, door locks, and electrically-operated sliding-door opening and closing.

To sum up the above-described construction, the feeder system 25 has the primary-side electromagnetic induction coil unit 26 serving as the first feeder unit and the secondary-side electromagnetic induction coil unit 27 serving as the second feeder unit, which are both arranged in units in each of which the respective components are grouped together as a set. The primary-side electromagnetic induction coil unit 26 and the secondary-side electromagnetic induction coil unit 27 are respectively constructed so as to be detachable with respect to the vehicle body 22 and the sliding door 23. Accordingly, in the same way as the above-described feeder system 4, the feeder system 25 becomes one which facilitates assembly and maintenance and is compact.

It goes without saying that the invention may be implemented by making various modifications within the range that does not change the gist of the invention. Namely, although in the above-described embodiment the examples of the two members recited in the claims are set as the vehicle body 2 (22) and the sliding door 3 (23), the invention is not limited to the same. For example, the vehicle body and a door unit other than the sliding door, and a tuner and a speaker in audio equipment can be cited as the two members. As other examples, it is possible to cite the steering of a door (the other member side: a steering portion) and a seat of an automobile (the other member side: a seat portion). It suffices if the two members require the supply of electric power and transmission of signals on a non-contact basis.

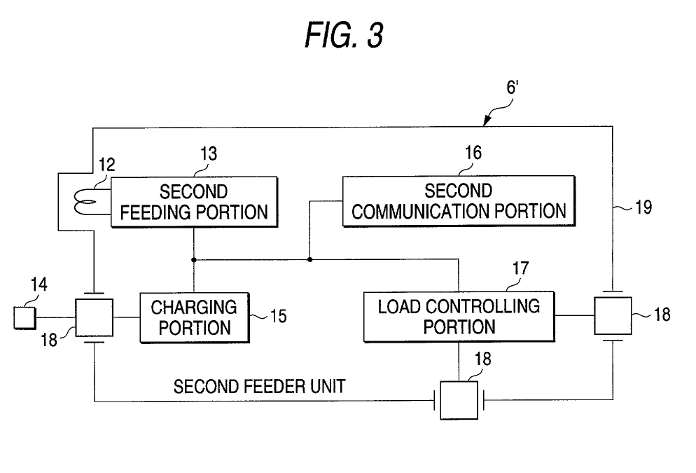

In addition, although in the above-described embodiment the storage member 14 of the second feeder unit 6 is arranged to be incorporated in the charging portion 15, the invention is not limited to the same. For example, as in the case of a second feeder unit 6′ shown in FIG. 3, the storage member 14 may be mounted detachably through the second external connecting portion 18. (Portions of the charging portion 15 excluding the storage member 14 are connected to the second external connecting portion 18, and the storage member 14 is detachably connected to the second external connecting portion 18. The other arrangements are the same as those of the second feeder unit 6. There is an advantage in that the maintenance is further facilitated.)

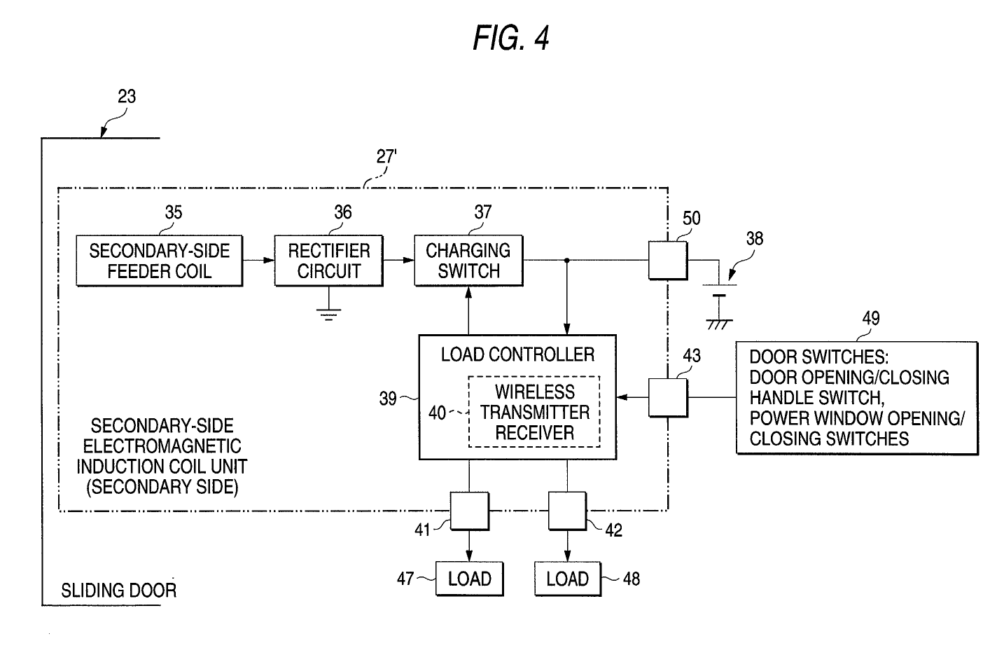

Although in the above-described embodiment the storage member 38 is arranged to be incorporated in the secondary-side electromagnetic induction coil unit 27, the invention is not limited to the same. For example, as in the case of a secondary-side electromagnetic induction coil unit 27′ (corresponding to the arrangement of the second feeder unit 6′) shown in FIG. 4, the storage member 38 may be mounted detachably through a connector 50 serving as the second external connecting portion. (The charging switch 37 is connected to the connector 50, and the storage member 38 is detachably connected to the connector 50. The other arrangements are the same as those of the secondary-side electromagnetic induction coil unit 27. There is an advantage in that the maintenance is further facilitated.)

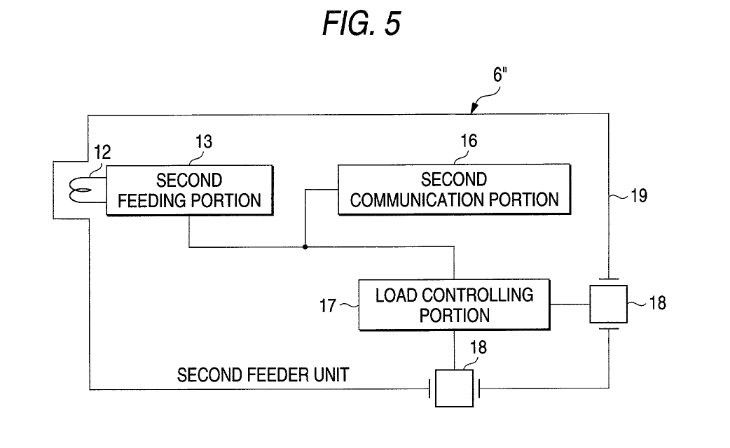

Although in the above-described embodiment the charging portion 15 having the storage member 14 is arranged to be incorporated in the second feeder unit 6, the invention is not limited to the same. For example, as in the case of a second feeder unit 6″ shown in FIG. 5, the charging portion 15 having the storage member 14 may be omitted (the second feeding portion 13 is directly connected to the load controlling portion 17).

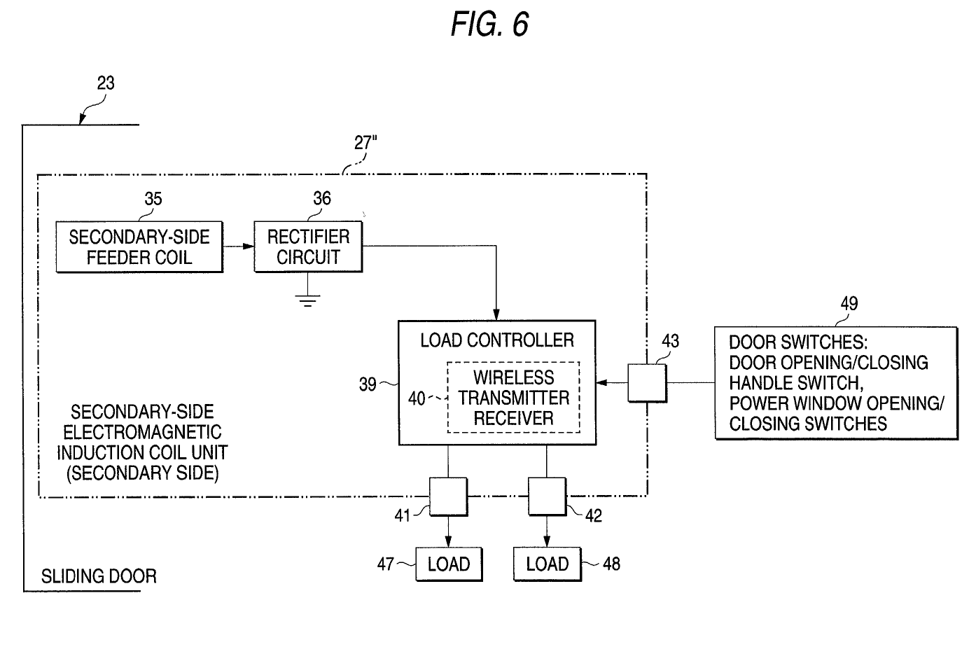

Similarly, although in the above-described embodiment the charging switch 37 and the storage member 38 are arranged to be incorporated in the secondary-side electromagnetic induction coil unit 27, the invention is not limited to the same. For example, as in the case of a secondary-side electromagnetic induction coil unit 27′ shown in FIG. 6, the charging switch 37 and the storage member 38 may be omitted (the rectifier circuit 36 is directly connected to the load controller 39).

As described above, in accordance with the invention, since the component members are arranged as sets which are respectively installed in units with respect to one of the two members and the other one thereof, it is possible to improve the operating efficiency concerning the assembly. Consequently, it is possible to attain a reduction in cost. Since the feeder system can be respectively removed from one of the two members and the other one thereof in units, the maintenance can be facilitated. Since the component parts are arranged in sets, the feeder system can be made compact in size. In consequence, it is possible to attain a reduction of the wire harness.

Accordingly, an advantage is offered in that it is possible to provide a feeder system which facilitates assembly and maintenance and is compact.

In accordance with the invention, an advantage is offered in that the other one of the two members can be operated with respect to one of the two members by wireless. Still another advantage is offered in that the feeder system can be made further compact.

In accordance with the invention, the operation of replacing the storage member can be coped with by the removal of only the storage member. Accordingly, an advantage is offered in that the maintenance can be further facilitated.

What is claimed is:

1. A feeder system comprising:
a first feeder unit which is detachably provided to a first member, and includes, as an integrated unit, a first feeding portion having a primary coil, a first communication portion for transmitting a control signal for a load to be driven, and a first external connecting portion for connecting the first feeding portion and the first communication portion, to an external circuit; and
a second feeder unit which is detachably provided to a second member adapted to be brought in to close proximity to the first member, and includes, as a integrated unit, a second feeding portion having a secondary coil which generates an induced electromotive force as the primary coil is brought into close proximity thereto, a second communication portion for receiving the control signal transmitted from the first communication portion, a second external connecting portion to which the load is connected, and a load controlling portion to which the second feeding portion, the second communication portion, and the second external connecting portion are connected and which controls the driving of the load.

2. The feeder system according to claim 1, wherein the second feeder unit includes a charging portion having a storage member capable of being charged with electric power supplied from the second feeding portion.

3. The feeder system according to claim 2, wherein the storage member is detachable from the second feeder unit.

4. The feeder system according to claim 1, wherein the load controlling portion is directly or indirectly connected to the second feeding portion, the second communication portion, and the second external connecting portion.

5. The feeder system according to claim 1, wherein the first member is a vehicle body, and the second member is a slide door mounted on the vehicle body.
